(19) United States
(12) Patent Application Publication
(10) Pub. No.: US 2017/0330566 A1
(43) Pub. Date: Nov. 16, 2017

(54) Distributed Volume Control for Speech Recognition

(71) Applicant: Bose Corporation, Framingham, MA (US)

(72) Inventors: Christian Trott, Charleston, SC (US); Michael J. Daley, Shrewsbury, MA (US); Christopher James Mulhearn, Worcester, MA (US)

(73) Assignee: Bose Corporation, Framingham, MA (US)

(21) Appl. No.: 15/593,788

(22) Filed: May 12, 2017

Related U.S. Application Data
(60) Provisional application No. 62/375,543, filed on Aug. 16, 2016.
(60) Provisional application No. 62/335,981, filed on May 13, 2016.

(51) Int. Cl. G10L 15/22; G06F 3/16; G10L 15/30; G10L 15/08

(52) U.S. Cl. CPC G10L 15/22; G10L 15/30; G10L 15/08; G06F 3/165; G10L 2015/088; G10L 2015/223

(57) ABSTRACT

A system includes a first device having a microphone associated with a voice user interface (VUI) and a first network interface, a first processor connected to the first network interface and controlling the first device, a second device having a speaker and a second network interface, and a second processor connected to the second network interface and controlling the second device. Upon connection of the second network interface to a network to which the first network interface is connected, the second processor causes the second device to output an identifiable sound through the speaker. Upon detecting the identifiable sound via the microphone, the first processor adds information identifying the second device to a data store of devices to be controlled when the first device activates the VUI.

### CROSS-REFERENCE

This application claims priority to provisional U.S. patent applications 62/335,981, filed May 13, 2016, and 62/375,543, filed Aug. 16, 2016, the entire contents of which are incorporated here by reference.

### BACKGROUND

This disclosure relates to distributed volume control for speech recognition.

Current speech recognition systems assume one microphone or microphone array is listening to a user speak and taking action based on the speech. The action may include local speech recognition and response, cloud-based recognition and response, or a combination of these. In some cases, a “wakeup word” is identified locally, and further processing is provided remotely based on the wakeup word.

Distributed speaker systems may coordinate the playback of audio at multiple speakers, located around a home, so that the sound playback is synchronized between locations.

### SUMMARY

In general, in one aspect, a system includes a first device having a microphone associated with a voice user interface (VUI) and a first network interface, a first processor connected to the first network interface and controlling the first device, a second device having a speaker and a second network interface, and a second processor connected to the second network interface and controlling the second device. Upon connection of the second network interface to a network to which the first network interface is connected, the second processor causes the second device to output an identifiable sound through the speaker. Upon detecting the identifiable sound via the microphone, the first processor adds information identifying the second device to a data store of devices to be controlled when the first device activates the VUI.

Implementations may include one or more of the following, in any combination. Upon detecting a wakeup word via the microphone, the first processor may retrieve the information identifying the second device from the data store, and send a command to the second device to lower the volume of sound being output by the second device via the speaker. The second processor may cause the output of the identifiable sound in response to receiving data from the first device over the network. A portion of the data received from the first device may be encoded in the identifiable sound. The first processor may cause the first device to transmit the data in response to receiving an identification of the second device over the network. The identifiable sound may encode data identifying the second device. The second processor may cause the output of the identifiable sound without receiving any data from the first device over the network. The second processor may inform the first processor over the network that the identifiable sound is about to be output.

The first processor may estimate a distance between the first device and the second device based on a signal characteristic of the identifiable sound as detected by the microphone, and store the distance in the data store. Upon detecting a wakeup word via the microphone, the first processor may retrieve, from the data store, the information identifying the second device and the estimated distance, and send a command to the second device based on the distance. The first processor may cause the first device to output a second identifiable sound using a speaker of the first device; upon detecting the second identifiable sound via a microphone of the second device, the second processor may report a time of the detection to the first processor, and the first processor may estimate the distance between the first device and the second device based on the time the second device detected the second identifiable sound. The first processor may cause the first device to output a second identifiable sound using a speaker of the first device; upon detecting the second identifiable sound via a microphone of the second device, the second processor may estimate the distance between the first device and the second device based on the time elapsed between when the second device produced the first identifiable sound and when it detected the second identifiable sound. The identifiable sound may include ultrasonic frequency components. The identifiable sound may include frequency components spanning at least two octaves.

In general, in one aspect, an apparatus includes a microphone for use with a voice user interface (VUI), a network interface, and a processor connected to the network interface and the VUI. Upon detecting connection of a remote device to a network to which the network interface is connected, followed by detecting an identifiable sound via the microphone, the identifiable sound being associated with the remote device, the processor adds information identifying the remote device to a data store of devices to be controlled when the processor accesses the VUI.

Implementations may include one or more of the following, in any combination. The processor may determine that the identifiable sound is associated with the remote device by detecting data encoded within the identifiable sound that corresponds to data received from the remote device over the network interface. The processor may be configured to transmit data to the remote device over the network interface, and the processor may determine that the identifiable sound is associated with the remote device by detecting data encoded within the identifiable sound that corresponds to the data transmitted to the remote device by the processor over the network interface. Upon detecting a wakeup word via the microphone, the processor may retrieve the information identifying the remote device from the data store, and send a command to the remote device over the network interface to lower the volume of sound being output by the second device via a speaker. The processor may estimate a distance between the apparatus and the remote device based on a signal amplitude of the identifiable sound as detected by the microphone, and store the distance in the data store. Upon detecting a wakeup word via the microphone, the processor may retrieves, from the data store, the information identifying the remote device and the estimated distance, and send a command to the remote device based on the distance. A speaker may be included, and the processor may cause the speaker to output a second identifiable sound, and upon receiving, via the network interface, data identifying a time that the second identifiable sound was detected by the remote device, the processor may estimate the distance between the apparatus and the remote device based additionally on the time the remote device detected the second identifiable sound.

In general, in one aspect, an apparatus includes a speaker, a network interface, and a processor connected to the network interface. Upon connection of the network interface to a network, the processor causes the device to output an identifiable sound through the speaker, the identifiable sound encoding data that identifies the apparatus.

Implementations may include one or more of the following, in any combination. The processor may further transmit data over the network interface that corresponds to the data encoded within the identifiable sound. The processor may receive data from a remote device over the network interface, and the processor may generate the data encoded within the identifiable sound based on the data received from the remote device over the network interface. Upon receiving a command from the remote device over the network interface, the processor may lower the volume of sound being output via a speaker. A microphone may be included; upon detecting, via the microphone, a second identifiable sound, the processor may transmit, over the network interface, data identifying a time that the second identifiable sound was detected.

Advantages include determining which speaker devices may interfere with intelligibility of spoken commands at a microphone device, and lowering their volume when spoken commands are being received.

All examples and features mentioned above can be combined in any technically possible way. Other features and advantages will be apparent from the description and the claims.

### BRIEF DESCRIPTION OF THE DRAWINGS

FIG. 1 shows a system layout of devices that may respond to voice commands.

FIGS. 2 and 3 show flow charts.

### DESCRIPTION

In some voice-controlled user interfaces (VUIs), a special phrase, referred to as a “wakeup word,” “wake word,” or “keyword” is used to activate the speech recognition features of the VUI—the device implementing the VUI is always listening for the wakeup word, and when it hears it, it parses whatever spoken commands came after it. This is done for various reasons, including accuracy, privacy, and to conserve network or processing resources, by not parsing every sound that is detected. In some examples, a problem arises that a device playing sounds (e.g., music) may degrade the ability to capture spoken audio of sufficient quality for processing by the VUI. When the same device is providing both the VUI and the audio output (such as a voice controlled loudspeaker), and it hears its wakeup word or otherwise starts its VUI capture process, it typically lowers or “ducks” its audio output level to better hear the ensuing command, or if appropriate, pauses the audio. A problem arises if the device producing the interfering sounds is remote from the one detecting the wakeup word and implementing the VUI.

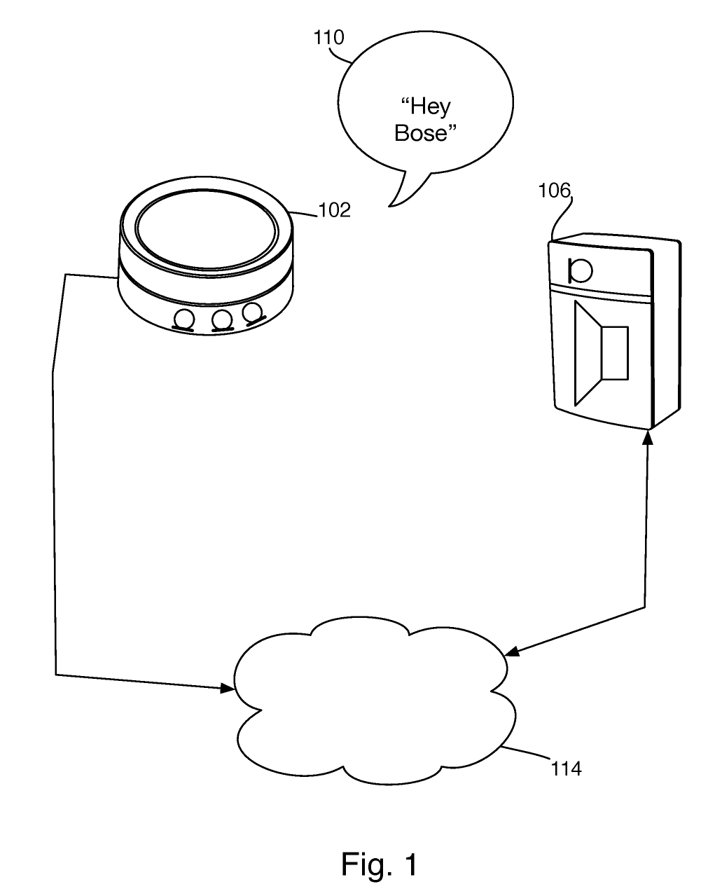

FIG. 1 shows a potential environment, in which a stand-alone microphone device 102 is near a loudspeaker device 106; the loudspeaker may also have microphones that detect a user's speech and other sounds. Similarly, the microphone array may also have an internal loudspeaker (not shown) for outputting sounds. Both devices could be the same type of device—we simply show one microphone device and one loudspeaker device to illustrate the relationship between producing sound and detecting it. To avoid confusion, we refer to the person speaking as the “user” and devices that output sound as “loudspeakers;” discrete things spoken by the user are “utterances,” e.g., wakeup word 110. The microphone device 102 and the loudspeaker device 106 are each connected to a network 114. Not shown, each of the microphone device and loudspeaker device have embedded processors and network interfaces, to varying degrees of sophistication, as necessary for carrying out the functions described below.

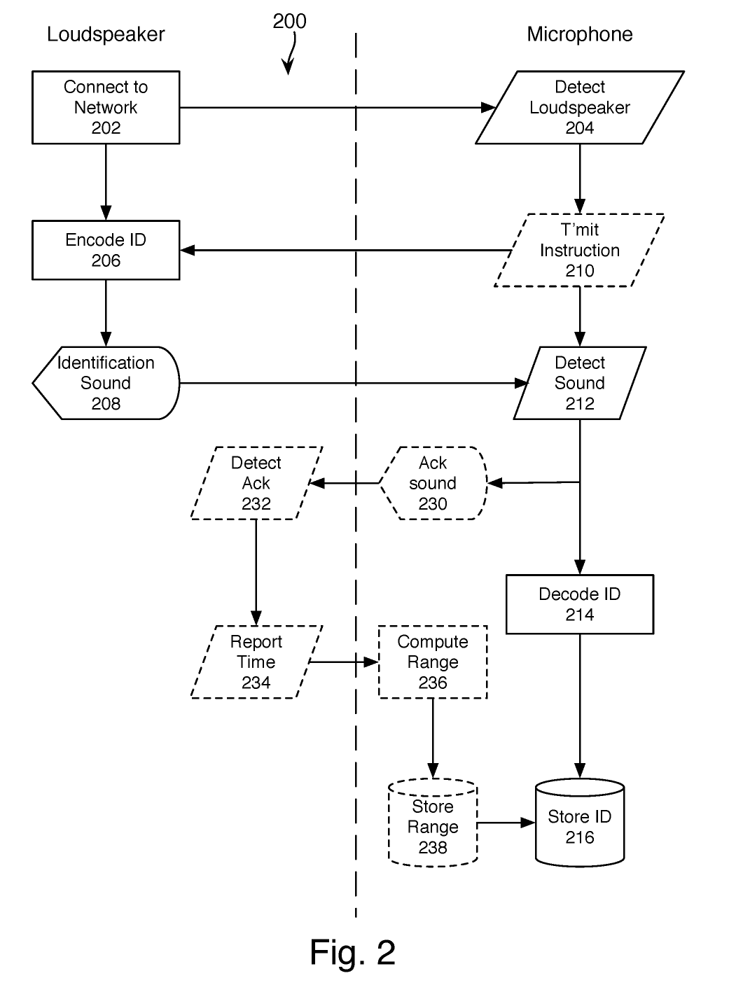

When the microphone device 102 detects the wakeup word 110, it tells nearby loudspeakers, which may include the loudspeaker device 106, to decrease their audio output level or pause whatever they are playing so that the microphone device can capture an intelligible voice signal. To know which loudspeakers to tell to lower their volume, a method is described for automatically determining which speakers are audible by the microphone device at the time the devices are connected to the network. This method is shown in the flow chart 200 of FIG. 2. On the left side are steps carried out by the loudspeaker device, and on the right are steps carried out by the microphone device.

In a first step (202), the loudspeaker device is connected to the network via its network interface. The microphone device observes (204) this connection, and may note identifying information about the loudspeaker device. The processor in the loudspeaker device then encodes (206) an identification of the loudspeaker in a sound file and causes the loudspeaker to play (208) the sound. There are several options for what data may be encoded in the identification sound. In a first example, a pre-determined identifier is encoded into the sound, which could be done by the processor at the time of operation or pre-stored in a configuration file, which could just be a pre-recorded sound. This identifier might correspond to some aspect of the loudspeaker device's network interface, such as its MAC address. Any data both transmitted on the network interface (as part of step 202 or in an additional step, not shown) and encoded in the identification sound would work in this example.

In a second example, the microphone device provides the data used to identify the loudspeaker device. In this example, the microphone device first transmits (210) an instruction to the loudspeaker device to identify itself, and the loudspeaker device's processor encodes some piece of data from that instruction into the sound in the encoding step 206.

Assuming the microphone device detects (212) the sound, it decodes (214) the data embedded in it and uses that data to identify the loudspeaker on the network. Once the loudspeaker is identified, the microphone device adds (216) the identification of the loudspeaker device to a table of nearby loudspeakers. The table could be in local memory or accessed over the network. In another example, no specific data is encoded in the audio. The loudspeaker device broadcasts on the network that it is about to send a sound, and then does so. Any device that hears the sound after the network broadcast adds the loudspeaker (identified by the network broadcast) to its table of nearby loudspeakers.

In the example where the loudspeaker encodes its own ID in the sound, the microphone device extracts that and matches it to the loudspeaker's network information to match the loudspeaker it hears to the loudspeaker it sees on the network. If the encoded ID is the loudspeaker's MAC address or other fixed network ID, it may not be necessary to have actually received the device information over the network. In the example where the loudspeaker encodes data sent by the microphone device into the identification sound, the microphone device matches the decoded data to the data it transmitted to confirm the identity of the loudspeaker.

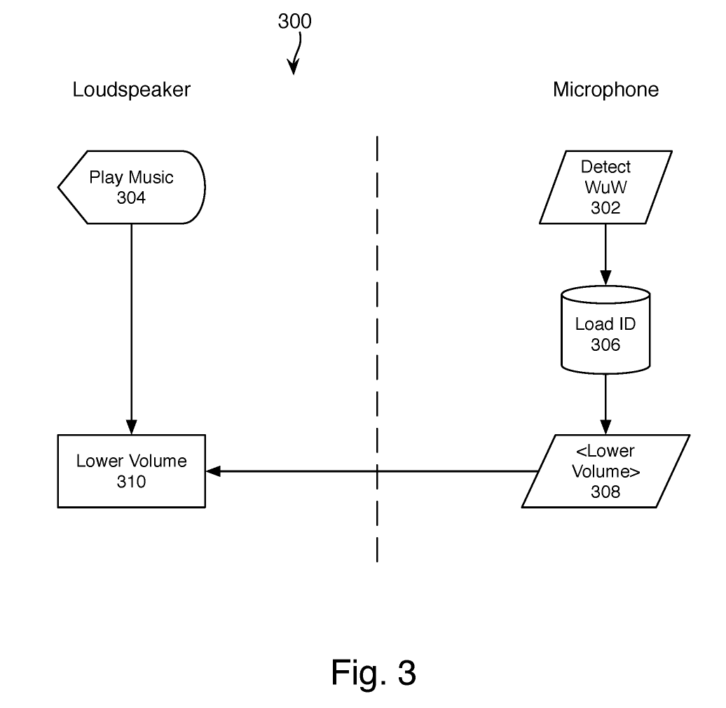

FIG. 3 shows a second flowchart 300 that shows how this data is used. When the microphone device detects (302) a wakeup word while the loudspeaker is playing music (304) or other interfering sounds, it looks up (306) from the table the list of nearby loudspeakers, and sends (308) a command to lower (310) the loudspeaker's volume to each nearby loudspeaker device. In some examples, the amount of volume reduction may be based on the current volume and the distance between the speaker and the microphone; this could be determined by either device, or cooperatively between them. Depending on the content and device configuration, the loudspeaker device may pause whatever it was playing in addition to or instead of lowering the audio. The microphone device may also choose to initiate the VUI on its own, such as based on a reminder or other proactive action, such that it knows the user is likely to speak without waiting for a wakeup word. In such a situation, the microphone device may look up nearby speakers and command them to lower their volume preemptively.

In addition to determining that the loudspeaker is close enough to be heard by its microphones, the microphone device may also determine the distance between the devices. In a simple implementation, this may be done simply based on the level of the identification sound detected by the microphones, especially if the microphone device knows what level the identification sound should have been output at—either from a predetermined setting, or because the level was communicated over the network. In another example, illustrated as optional steps of the flow chart 200 of FIG. 2, the microphone device plays (230) an acknowledgement sound over its own loudspeaker. This is shown between the detecting of the sound and decoding of the ID, but could be done earlier or later in the process. The loudspeaker device detects (232) this sound on its microphone, and it reports (234) back to the microphone device the time that it detected the sound (the devices' clocks being synchronized by the network). If the loudspeaker device knows how long it takes the microphone device to interpret the sound it heard and send back its own sound, or can otherwise have confidence in the transmission time (such as arranged simultaneous or sequential transmission), the total acoustic time of flight could be used to measure the distance without the need for clock synchronization. As the microphone device knows the time that it output the sound, it can compute (236) from the time-of-flight how far apart the devices are. The same could be done with the loudspeaker device's identification sound, if the loudspeaker device transmits over the network the time that it output the initial identification sound. The distance is then stored (238) with the loudspeaker's device ID and used to determine which loudspeakers should be controlled when the VUI is in use.

Of course, all of the above can be done in reverse or in other combinations;

for example, if the loudspeaker device is on the network first, it can play its identification sound when the microphone device is subsequently connected to the network. This could be in response to seeing that a microphone device has been added to the network, or in response to receiving a specific request from the microphone device to play the sound. Where both devices have loudspeakers and microphones, they may both take both roles, playing sounds and recording the identifications of from which devices they each detected sounds. Alternatively, only one may play a sound, and it may be informed that it was heard by the other device, so they can both record their mutual proximity, on the assumption that audibility is reciprocal. The method may also be performed at other times, such as any time that motion sensors indicate that one of the devices has been moved, or on a schedule, to account for changes in the environment that the devices cannot detect otherwise.

The processing described may be performed by a single computer processor or a distributed system. The speech processing provided may similarly be provided by a single computer or a distributed system, coextensive with or separate from the device processors system. They each may be located entirely locally to the devices, entirely in the cloud, or split between both. They may be integrated into one or all of the devices. The various tasks described—encoding identifiers, decoding identifiers, computing distances, etc., may be combined together or broken down into more sub-tasks. Each of the tasks and sub-tasks may be performed by a different device or combination of devices, locally or in a cloud-based or other remote system.

When we refer to microphones, we include microphone arrays without any intended restriction on particular microphone technology, topology, or signal processing. Similarly, references to loudspeakers should be understood to include any audio output devices—televisions, home theater systems, doorbells, wearable speakers, etc.

Embodiments of the systems and methods described above comprise computer components and computer-implemented steps that will be apparent to those skilled in the art. For example, it should be understood by one of skill in the art that instructions for executing the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

A number of implementations have been described. Nevertheless, it will be understood that additional modifications may be made without departing from the scope of the inventive concepts described herein, and, accordingly, other embodiments are within the scope of the following claims.

What is claimed is:

1. A system comprising:
a first device having a microphone associated with a voice user interface (VUI), and a first network interface;
a first processor connected to the first network interface and controlling the first device;
a second device having a speaker and a second network interface; and
a second processor connected to the second network interface and controlling the second device;
wherein
upon connection of the second network interface to a network to which the first network interface is connected,
the second processor causes the second device to output an identifiable sound through the speaker,
upon detecting the identifiable sound via the microphone, the first processor adds information identifying the second device to a data store of devices to be controlled when the first device activates the VUI.

2. The system of claim 1, wherein:
upon detecting a wakeup word via the microphone, the first processor retrieves the information identifying the second device from the data store, and sends a command to the second device to lower the volume of sound being output by the second device via the speaker.

3. The system of claim 1, wherein the second processor causes the output of the identifiable sound in response to receiving data from the first device over the network.

4. The system of claim 3, wherein a portion of the data received from the first device is encoded in the identifiable sound.

5. The system of claim 3, wherein the first processor causes the first device to transmit the data in response to receiving an identification of the second device over the network.

6. The system of claim 1, wherein the identifiable sound encodes data identifying the second device.

7. The system of claim 1, wherein the second processor causes the output of the identifiable sound without receiving any data from the first device over the network.

8. The system of claim 7, wherein the second processor informs the first processor over the network that the identifiable sound is about to be output.

9. The system of claim 1, wherein the first processor estimates a distance between the first device and the second device based on a signal characteristic of the identifiable sound as detected by the microphone, and stores the distance in the data store.

10. The system of claim 9, wherein:
upon detecting a wakeup word via the microphone, the first processor retrieves, from the data store, the information identifying the second device and the estimated distance, and sends a command to the second device based on the distance.

11. The system of claim 1, wherein:
the first processor causes the first device to output a second identifiable sound using a speaker of the first device,
upon detecting the second identifiable sound via a microphone of the second device, the second processor reports a time of the detection to the first processor, and
the first processor estimates the distance between the first device and the second device based on the time the second device detected the second identifiable sound.

12. The system of claim 1, wherein:
the first processor causes the first device to output a second identifiable sound using a speaker of the first device,
upon detecting the second identifiable sound via a microphone of the second device, the second processor estimates the distance between the first device and the second device based on the time elapsed between when the second device produced the first identifiable sound and when it detected the second identifiable sound.

13. The system of claim 1, wherein the identifiable sound comprises ultrasonic frequency components.

14. The system of claim 1, wherein the identifiable sound comprises frequency components spanning at least two octaves.

15. An apparatus comprising:
a microphone for use with a voice user interface (VUI);
a network interface; and
a processor connected to the network interface and the VUI;
wherein
upon detecting connection of a remote device to a network to which the network interface is connected,
followed by detecting an identifiable sound via the microphone, the identifiable sound being associated with the remote device,
the processor adds information identifying the remote device to a data store of devices to be controlled when the processor accesses the VUI.

16. The apparatus of claim 15, wherein the processor determines that the identifiable sound is associated with the remote device by detecting data encoded within the identifiable sound that corresponds to data received from the remote device over the network interface.

17. The apparatus of claim 15, wherein the processor is configured to transmit data to the remote device over the network interface, and the processor determines that the identifiable sound is associated with the remote device by detecting data encoded within the identifiable sound that corresponds to the data transmitted to the remote device by the processor over the network interface.

18. The apparatus of claim 15, wherein:
upon detecting a wakeup word via the microphone, the processor retrieves the information identifying the remote device from the data store, and sends a command to the remote device over the network interface to lower the volume of sound being output by the second device via a speaker.

19. The apparatus of claim 15, wherein the processor estimates a distance between the apparatus and the remote device based on a signal amplitude of the identifiable sound as detected by the microphone, and stores the distance in the data store.

20. The apparatus of claim 19, wherein:
upon detecting a wakeup word via the microphone, the processor retrieves, from the data store, the information identifying the remote device and the estimated distance, and sends a command to the remote device based on the distance.

21. The apparatus of claim 19, further comprising a speaker, and wherein:
the processor causes the speaker to output a second identifiable sound, and
upon receiving, via the network interface, data identifying a time that the second identifiable sound was detected by the remote device,
the processor estimates the distance between the apparatus and the remote device based additionally on the time the remote device detected the second identifiable sound.

22. An apparatus comprising:
a speaker;
a network interface; and
a processor connected to the network interface;
wherein
upon connection of the network interface to a network,
the processor causes the device to output an identifiable sound through the speaker, the identifiable sound encoding data that identifies the apparatus.

23. The apparatus of claim 22, wherein the processor further transmits data over the network interface that corresponds to the data encoded within the identifiable sound.

24. The apparatus of claim 22, wherein the processor is configured to receive data from a remote device over the network interface, and the processor generates the data encoded within the identifiable sound based on the data received from the remote device over the network interface.

25. The apparatus of claim 22, wherein:
upon receiving a command from the remote device over the network interface, the processor lowers the volume of sound being output via a speaker.

26. The apparatus of claim 22, further comprising a microphone, and wherein:
upon detecting, via the microphone, a second identifiable sound,
the processor transmits, over the network interface, data identifying a time that the second identifiable sound was detected.
